(19) United States
(12) Patent Application Publication
(10) Pub. No.: US 2006/0267312 A1
(43) Pub. Date: Nov. 30, 2006

(54) Airbag cover and method for producing airbag cover

(75) Inventors: Paul David Slade, Highpoint, NC (US); Roberto Buiocchi, Jundiai (BR)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/135,653

(22) Filed: May 24, 2005

(51) Int. Cl. B28B 7/14; A21C 11/10; B60R 21/215

(52) U.S. Cl. 280/728.3; 264/163; 425/289

(57) ABSTRACT

An airbag cover includes a surface configured to face a passenger compartment of a vehicle and at least one tear seam configured to rupture upon inflation of an airbag. The at least one tear seam is formed as a relatively thin region of the cover and is not visible to an unaided human eye viewing the surface.

### BACKGROUND

The present invention is generally related to airbags. More specifically, the present invention is related to methods and equipment for manufacturing airbags.

Inflatable airbags have become standard equipment in modern automobiles. Such airbags typically include a bag portion that inflates when a predetermined condition is met (e.g., an automobile impact). A cover for the airbag assembly is provided to conceal the inflatable bag from vehicle occupants. Such a cover may be provided as part of a steering wheel or dashboard assembly or elsewhere in the vehicle. The cover may have an exterior surface that matches or complements colors and/or materials used within the vehicle compartment.

Inflation of the airbag forces the cover apart at one or more predetermined locations, which allows the airbag to inflate toward a vehicle occupant. Such predetermined locations may be molded into the cover (e.g., on a rear surface thereof opposite the surface which faces the vehicle interior) as tear seams.

In some cases, the airbag cover may be produced from a polymeric material in an injection molding process. To produce a tear seam, the mold may include a feature that extends into the mold cavity to form a relatively thin section in the airbag cover as compared to its surrounding area. In this manner, the thinner area may act as a point of weakness that ruptures upon inflation of the airbag.

One disadvantage of typical injection molding processes used to form airbag covers is that such processes may result in the formation of a visible line or other visual defects on the exterior surface of the airbag cover. Such defects may be formed because of thermal and pressure differences between the location of the tear seam and the surrounding area. For example, because the thickness of the cover at the location of the tear seam is less than that of the surrounding area, the material will flow more slowly in this region. As the material continues to flow past the narrow portion of the mold and into a thicker portion of the mold, a pressure drop occurs due to the increased speed of the material, which may result in the formation of bulges or other defects that may be visible on the passenger side of the airbag cover in the location of the tear seam.

It would be desirable to provide an improved system and method for producing an airbag cover having a tear seam. For example, it would be desirable to provide a system and method for producing such an airbag cover that does not result in the formation of a visible line on an exterior surface of the airbag cover.

### SUMMARY

An exemplary embodiment of the invention relates to an airbag cover that includes a surface configured to face a passenger compartment of a vehicle and at least one tear seam configured to rupture upon inflation of an airbag. The at least one tear seam is formed as a relatively thin region of the cover and is not visible to an unaided human eye viewing the surface.

Another exemplary embodiment of the invention relates to a cover for an airbag assembly produced by a method that includes heating a portion of a mold configured to form an airbag cover at a location where a tear seam is to be formed in the cover, the tear seam comprising a relatively thin region of the cover and injecting a polymeric material into the mold after the heating step to form the cover and the tear seam. A surface of the cover does not include visible defects at the location of the tear seam.

Another exemplary embodiment of the invention relates to a system for producing a cover for an airbag assembly that includes a mold for forming a cover for an airbag, the cover comprising at least one tear seam and an element for providing heat at a location where the tear seam is to be formed during molding of the cover.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims and the accompanying exemplary embodiments shown in the drawings, which are briefly described below.

FIG. 1 is a plan view of a first surface of an airbag cover according to an exemplary embodiment.

FIG. 2 is a plan view of a second surface of the airbag cover shown in FIG. 1 according to an exemplary embodiment.

FIG. 3 is a cross-sectional view of a portion of the airbag cover shown in FIG. 1 taken across line 3-3 at the location of a tear seam according to an exemplary embodiment.

FIG. 4 is a cross-sectional view of an injection molding system for producing an airbag cover according to an exemplary embodiment.

FIG. 5 is another cross-sectional view of the injection molding system shown in FIG. 4 according to an exemplary embodiment.

### DETAILED DESCRIPTION

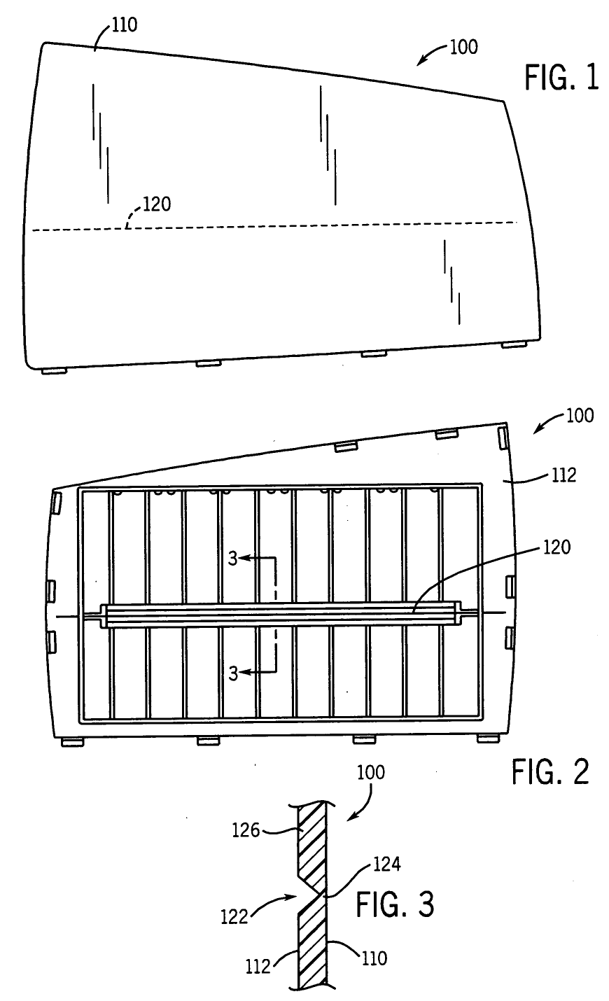

Referring to FIGS. 1 and 2, a cover 100 for an airbag assembly is shown according to an exemplary embodiment. The cover 100 includes a first surface 110 (e.g., which faces toward the passenger compartment of an automobile when the cover 100 is installed, and may be referred to as the exterior or “A” surface of the cover 100) and a second surface 112 opposite the first surface 110. As shown in FIG. 1, the cover 100 may be used with passenger side airbags used in vehicles. It should be noted that according to other exemplary embodiments, covers may be produced for use in driver side (e.g., steering wheel) applications using methods such as those described below.

According to an exemplary embodiment, the cover 100 may be made from a polymeric material such as a thermoplastic olefin (TPO) material (e.g., polypropylene or polyethylene copolymers, etc.) or a thermoplastic elastomer (TPE) material (e.g., polyurethanes, polyester copolymers, styrene copolymers etc.). The cover 100 may also be provided in any of a wide range of colors and textures as may be desired for a particular application.

One or more tear seams may be provided in the cover. Such tear seams act as points of weakness where the cover 100 will break or rupture upon inflation of an airbag. According to an exemplary embodiment shown in FIG. 1, a single tear seam is provided in the cover 100. The location of the tear seam is designated in FIGS. 1 and 2 as a dashed line 120. It should be noted that while dashed line 120 in FIG. 1 shows the location of the tear seam, it is intended that the tear seam will not be visible at the first surface 110 of the cover 100 (i.e., the side of the cover visible to a passenger in a vehicle).

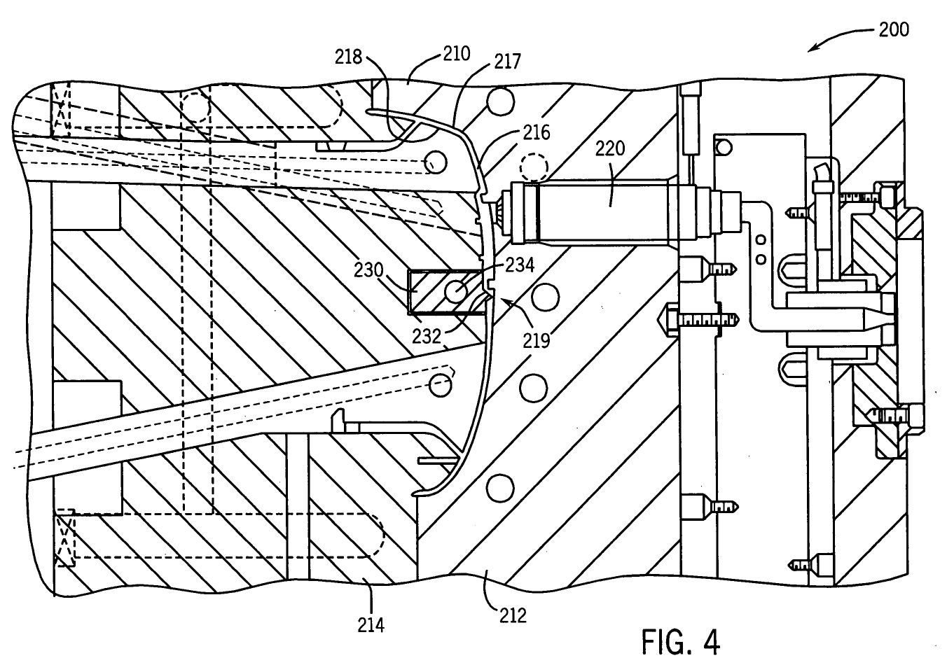

FIG. 3 is a cross-sectional view of a portion of the cover 100 taken across line 3-3 in FIG. 2. As shown in FIG. 3, the tear seam is formed such that the cover is thinner (e.g., at a first location 124) than the surrounding areas of the cover (e.g., at a second location 126). Stated another way, the cover includes a feature in the form of an indent or cutout at the location of the tear seam. While FIG. 3 shows the indent as having a generally triangular cross-sectional shape, other configurations for the tear seam may be utilized according to other exemplary embodiments.

According to an exemplary embodiment, the thickness of the cover at the location of the tear seam (e.g., at the first location 124 shown in FIG. 3) is between approximately 0.3 and 1.2 millimeters and the thickness of the surrounding area of the cover (e.g., at the second location 126 shown in FIG. 3) is between approximately 2.5 and 4.5 millimeters. The differential thicknesses may thus provide a relatively weakened area of the cover at the location of the tear seam that is configured to rupture or break upon inflation of the airbag.

As shown in FIG. 3, the surface 110 of the cover 100 in the location of the tear seam and in the surrounding areas is generally flat or planar. For example, the surface 110 has a relatively uniform and continuous surface appearance that does not include bulges, protrusions, troughs, indents, or other defects that would be visible to the unaided human eye. In this manner, the tear seam is not visible or discernible to an unaided human eye viewing the surface 110 when the cover 100 is installed in a vehicle.

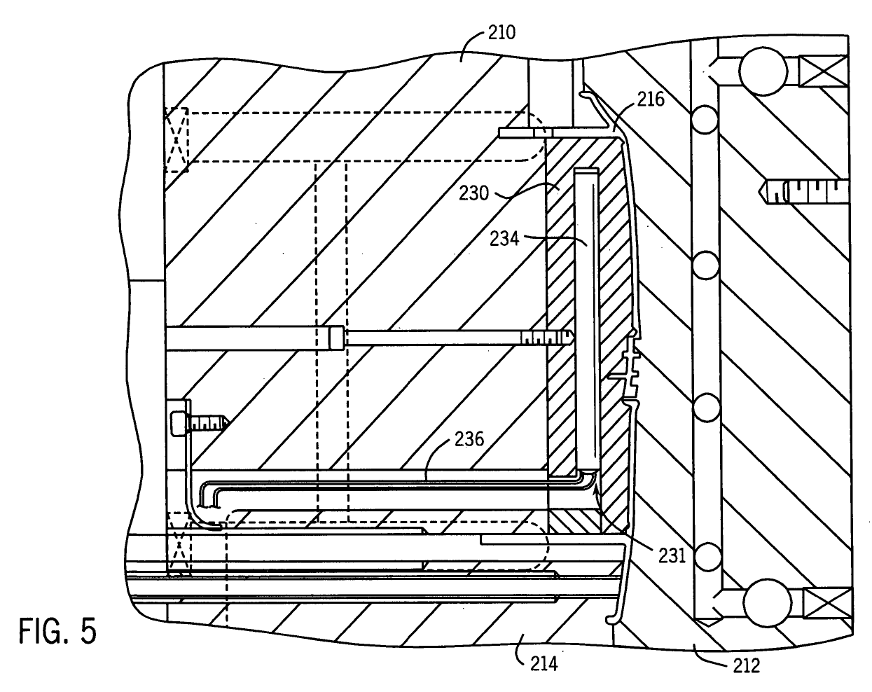

FIGS. 4 and 5 are cross-sectional views of a portion of an injection molding system 200 for producing airbag covers such as the cover 100 shown in FIGS. 1-3 or other covers (e.g., for use in driver side applications, such as for steering wheel covers). FIGS. 4 and 5 illustrate the use of the injection molding system 200 to form a driver side airbag cover. According to an exemplary embodiment, the injection molding system 200 is a DME & Incoe injection molder commercially available from Itatiba of San Paulo, Brazil.

The injection molding system 200 includes a mold 210 that includes a first mold portion 212 having a first wall 217 and a second mold portion 214 having a second wall 218. The first portion 212 and the second portion 214 define a cavity 216 into which a polymeric material may be provided (e.g., injected) by a device 220 (e.g., an injector). The first portion 212 and the second portion 214 may be made from any suitable material, including any suitable metal (e.g., steel, cast iron, etc.).

The first portion 212 and the second portion 214 are configured for movement relative to one another (e.g., to bring the first portion 212 and second portion 214 together to form the cavity 216 or to separate the first portion 212 and second portion 214 to allow removal or ejection of an airbag cover formed in the cavity).

According to an exemplary embodiment, a member or element 230 in the form of an insert is provided as part of the molding system 200 to provide localized heating in the mold. The member 230 forms a portion of the second wall 218 (FIG. 4) and acts to provide heat at a location or region 219 of the mold 210 corresponding to the location of the tear seam to be formed in an airbag cover. According to other exemplary embodiments, a member such as member 230 may be provided in contact with a portion of a mold wall (e.g., the member would not form a portion of the mold wall surface, but would be external to the mold at an appropriate location).

According to an exemplary embodiment, the member 230 includes a protrusion or extension 232 that extends into the mold cavity 216 where the tear seam is to be formed, as shown in FIG. 4. The protrusion 232 thus defines a portion of the mold responsible for forming the tear seam by providing a relatively narrow or thin portion in the mold cavity 216.

According to an exemplary embodiment, the member 230 is made from a beryllium-copper alloy. One advantageous feature of using a beryllium-copper alloy to form the member 230 is that such a material is a relatively good heat absorber. According to other exemplary embodiments, various other materials may be used to form the member, such as Mold Max and high density steel.

While one particular example of a member (member 230) is shown in FIGS. 4 and 5, it should be noted that the size, shape, and configuration of such a member may vary according to other exemplary embodiments. The size, shape, and configuration of the member(s) provided according to other exemplary embodiments may depend, for example, on the size, shape, and configuration of the tear seam to be produced or on the amount of heating and control desired, among other considerations. Also, while only one member 230 is shown in FIGS. 4 and 5, according to other exemplary embodiments, a different number of members may be provided (e.g., depending on the number of tear seams to be formed, etc.).

As shown in FIGS. 4 and 5, a heating element or device 234 in the form of a cartridge heater is provided within an aperture or channel 231 provided in the member 230. Conductors such as wires 236 may be provided to electrically couple the heating element 234 to a controller that may be used to control the amount of heat generated by the heating element 234. According to a particular exemplary embodiment, the heating element is a Incoe molding tool commercially available from Itatiba of San Paulo, Brazil. According to various other exemplary embodiments, other types of heaters may be used to provide heat to element 230.

According to an exemplary embodiment in which the material used to form the airbag cover is a thermoplastic olefin material, the member 230 is heated to a temperature of between approximately 400° F. and 470° F. during introduction of the material into the mold 210. According to a particular exemplary embodiment, the member 230 is heated to a temperature above approximately 417° F. during the molding operation, which is above the melt flow temperature of the material.

One advantageous feature of providing heat to the mold 210 at the location where the one or more tear seams are to be formed is that adverse effects which may result from the shape of the mold 210 in these areas may be reduced. For example, because the temperature of the mold at the narrow region of the mold is elevated as compared to other regions of the mold, the material flowing past the narrow region is able to travel more quickly at this point than would otherwise be possible. As a result, the heating of the mold at this location reduces the pressure drop that results as the material flows from the narrow region into a wider region of the mold. Also, because the material at the location 219 is maintained at an elevated temperature during the molding operation (which typically has a cycle time of up to approximately 60 seconds), the material does not cool in this area at a rate that is significantly faster than that of the surrounding material, thus reducing the occurrence of defects which may result from differences in the cooling and corresponding shrinkage of the material.

It is important to note that the construction and arrangement of the molding system as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions as expressed in the appended claims.

What is claimed is:

1. An airbag cover comprising:
a surface configured to face a passenger compartment of a vehicle; and
at least one tear seam configured to rupture upon inflation of an airbag;
wherein the at least one tear seam is formed as a relatively thin region of the cover and is not visible to an unaided human eye viewing the surface.

2. The airbag cover of claim 1, wherein the thickness of the cover at the tear seam is between approximately 0.3 and 1.2 millimeters and the thickness of surrounding areas of the cover are between approximately 2.5 and 4.5 millimeters.

3. The airbag cover of claim 1, wherein the cover comprises a plurality of tear seams.

4. The airbag cover of claim 1, wherein the surface is generally planar at the location of the tear seam.

5. The airbag cover of claim 1, wherein the surface does not include visible defects at the location of the tear seam.

6. The airbag cover of claim 1, wherein the cover comprises a polymeric material.

7. The airbag cover of claim 1, wherein the polymeric material comprises a thermoplastic olefin material.

8. A cover for an airbag assembly produced by a method comprising:
heating a portion of a mold configured to form an airbag cover at a location where a tear seam is to be formed in the cover, the tear seam comprising a relatively thin region of the cover; and
injecting a polymeric material into the mold after the heating step to form the cover and the tear seam;
wherein a surface of the cover does not include visible defects at the location of the tear seam.

9. The cover of claim 8, wherein the heating step comprises heating the portion of the mold to a temperature greater than approximately 417° F.

10. The cover of claim 8, wherein the polymeric material comprises a thermoplastic material.

11. The cover of claim 8, wherein the mold comprises an element for heating the portion of the mold at the location.

12. The cover of claim 8, wherein the step of heating the portion of the mold utilizes an insert having a heater provided therein.

13. The cover of claim 12, wherein the insert defines at least a portion of the tear seam.

14. A system for producing a cover for an airbag assembly comprising:
a mold for forming a cover for an airbag, the cover comprising at least one tear seam; and
an element for providing heat at a location where the tear seam is to be formed during molding of the cover.

15. The system of claim 14, wherein the mold is part of an injection molding apparatus.

16. The system of claim 14, wherein the element for providing heat comprises an insert that forms a portion of a wall of the mold.

17. The system of claim 16, further comprising a heating device provided within at least a portion of the insert.

18. The system of claim 14, wherein the element is configured for heating a portion of the mold to a temperature of between approximately 400 and 470 degrees Fahrenheit.

19. The system of claim 14, wherein the element is configured for providing heat along only a portion of the tear seam.

20. The system of claim 14, wherein the element is configured for providing heat along substantially the entire tear seam.
